(19) United States
(12) Patent Application Publication
(10) Pub. No.: US 2017/0248999 A1
(43) Pub. Date: Aug. 31, 2017

(54) Inductive Peripheral Retention Device

(71) Applicant: Microsoft Technology Licensing, LLC, Redmond, WA (US)

(72) Inventors: Shiu Sang NG, Kirkland, WA (US); Timothy Allen JAKOBOSKI, Woodinville, WA (US)

(73) Assignee: Microsoft Technology Licensing, LLC, Redmond, WA (US)

(21) Appl. No.: 15/594,435

(22) Filed: May 12, 2017

Related U.S. Application Data
(63) Continuation-in-part of application No. 15/209,539, filed on Jul. 13, 2016.
Application No. 15/209,539 is a division of application No. 14/486,381, filed on Sep. 15, 2014, now Pat. No. 9,424,048.

(51) Int. Cl. G06F 1/26; G06F 13/10; G06F 1/32

(52) U.S. Cl. CPC G06F 1/266; G06F 1/3287; G06F 13/102; G06F 3/03545

(57) ABSTRACT

Inductive peripheral retention device techniques are described. In one or more implementations, a peripheral retention device includes an inductive element comprising one or more inductive coils integrated into a surface of the peripheral retention device. The peripheral retention device also includes a peripheral securing element configured to secure a peripheral device to the surface of the peripheral retention device to form a communicative coupling with the peripheral device via the one or more inductive coils. In some cases, the peripheral securing element includes one or more magnets configured to secure the peripheral device to the peripheral retention device such that the one or more inductive coils of the peripheral retention device are aligned with one or more corresponding inductive coils of the peripheral device.

### RELATED APPLICATIONS

This application is a continuation-in-part of U.S. patent application Ser. No. 15/209,539, filed Jul. 13, 2016 which is a divisional of and claims priority to U.S. patent application Ser. No. 14/486,381, filed Sep. 15, 2014, entitled “Inductive Peripheral Retention Device”, now U.S. Pat. No. 9,424,048, the entire disclosures of which are hereby incorporated by reference herein in their entirety.

### BACKGROUND

Computing devices may employ peripheral devices to aid a user in interacting with the computing device. An example of this is an alternate input device, such as a stylus, that may be used to aid a user in interacting with touchscreen and other functionality of the computing device. A user, for instance, may utilize the stylus to draw on a surface of the touchscreen to make annotations, notes, and other indicia.

Conventional techniques utilized to store the stylus, however, could be problematic in a number of different ways. For example, use of an internal slot to store and retain the stylus through friction or through a push-push type mechanism may create a problem where extra space and parts are required inside the device. This may also cause an increase in the complexity of the device, overall size of the device which may be undesirable for mobile configurations, and may therefore hinder the user's experience with the device.

In another example, use of a lanyard and a pen cap may operate somewhat as an uncontrolled appendage and therefore get caught on other objects, pen caps tend to let the pen fall out due to limitations of a retention force that may be used, and so on. Consequently, a user may choose to forgo use of this additional functionality supported by the peripheral device due to these complications.

### SUMMARY

Inductive peripheral retention device techniques are described. In one or more implementations, an apparatus includes a plug configured to removably engage a communication port of a device to form a communicative coupling with the device. The plug is securable to and removable from the device using one or more hands of a user. The apparatus also includes a peripheral securing portion connected to the plug and configured to removably engage a peripheral device via an inductive element formed as a flexible loop and configured to form a communicative coupling between the peripheral device and the device.

In one or more implementations, inductance is detected of a flexible element configured to transfer power to a peripheral device via inductance. Responsive to a determination that the detected inductance is above a threshold, a first power mode is utilized in which a first amount of power is provided to the flexible element. Responsive to a determination that the detected inductance is below a threshold, a second power mode is utilized in which a second amount of power is provided to the flexible element that is less than the first amount of power.

In one or more implementations, an apparatus includes a single ferrous element formed as a single integral piece having a middle portion having a diameter about an axis that is less than a diameter of opposing ends of the single ferrous element along the axis and a coil wrapped around the middle portion such that the coil and the single ferrous element form an inductive coil that is substantially rotationally invariant around the axis when charging.

In one or more implementations, a peripheral retention device includes an inductive element comprising one or more inductive coils integrated into a surface of the peripheral retention device. The peripheral retention device also includes a peripheral securing element configured to secure a peripheral device to the surface of the peripheral retention device to form a communicative coupling with the peripheral device via the one or more inductive coils. In some cases, the peripheral securing element includes one or more magnets configured to secure the peripheral device to the peripheral retention device such that the one or more inductive coils of the peripheral retention device are aligned with one or more corresponding inductive coils of the peripheral device.

In one or more implementations, a ping signal is communicated via one or more inductive coils of a peripheral retention device integrated within a device, and it is determined whether a reply signal is received from a peripheral device secured to the peripheral retention device. In response to a determination that the reply signal is received, a first power mode is utilized in which a first amount of power is provided to the inductive coils of the peripheral retention device, and in response to a determination that the reply signal is not received, a second power mode is utilized in which a second amount of power is provided to the inductive coils of the peripheral retention device that is less than the first amount of power.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein to secure and charge a peripheral device.

FIG. 2 depicts an example implementation showing different views of an example of a peripheral retention device of FIG. 1.

FIG. 3 depicts an example implementation showing retention of a peripheral device configured as a stylus by the peripheral retention device of FIG. 2 thereby securing the stylus to a computing device.

FIG. 4 depicts another example implementation in which the peripheral retention device of FIG. 3 is used to secure the stylus to a standalone display device.

FIG. 5 depicts an example implementation in which an inductive element of a peripheral retention device of FIG. 2 is configured to support flexible movement and stretching.

FIG. 6 depicts an example implementation in which an inductive element of FIG. 5 is bent to form a flexible loop.

FIG. 7 depicts an example implementation in which the inductive element of FIG. 6 is installed as part of the peripheral retention device of FIG. 2.

FIG. 8 depicts an example implementation of secondary coil usage by a peripheral device of FIG. 1 to form an inductive communicative coupling between devices.

FIG. 9 depicts an example implementation in which an inductive coil of FIG. 8 is configured to operate as a primary coil in an air gap transformer arrangement.

FIG. 10 illustrates an example implementation of a peripheral retention device in accordance with one or more implementations.

FIG. 11 illustrates example implementations in which a peripheral device is secured to a surface of the peripheral retention device integrated into the housing of a device.

FIG. 12 illustrates another example implementation in which a peripheral device is secured to a surface of the peripheral retention device integrated into the housing of a device.

FIG. 13 illustrates an example implementation of a peripheral retention device in accordance with one or more implementations.

FIG. 14 illustrates an additional example implementation of a peripheral retention device in accordance with one or more implementations.

FIG. 15 depicts an example implementation in which power modes are utilized to control an amount of power provided to the inductive element of FIG. 5 of the peripheral retention device of FIG. 2 or FIG. 10.

FIG. 16 depicts an example implementation of a circuit usable by a peripheral retention device to act as a primary coil of an air gap transformer.

FIG. 17 is a flow chart depicting a procedure in an example implementation in which power modes are utilized based on a determination of a detection of inductance of a flexible loop.

FIG. 18 depicts a procedure in an example implementation in which different power modes are utilized in accordance with one or more implementations.

FIG. 19 illustrates an example system including various components of an example device that can be implemented as any type of computing device as described with reference to FIGS. 1-18 to implement embodiments of the techniques described herein.

### DETAILED DESCRIPTION

Overview

Computing devices may employ a wide range of peripheral devices to support different types of user interaction with the device. This may include input devices that are configured to be used in addition to the computing device, an example of which is a stylus. However, conventional techniques that are utilized to store peripheral devices are often cumbersome and hindered a user's interaction with both the peripheral device and the computing device.

Inductive peripheral retention device techniques are described. In one or more implementations, a peripheral retention device is configured to be secured to a computing device or other device (e.g., a peripheral device of the computing device such as a monitor, keyboard, and so on) using a plug that is configured to engage a communication port, e.g., a USB port or other port. The peripheral retention device also includes a peripheral securing portion that is connected to the plug to retain a peripheral device, such as a stylus.

The peripheral securing portion, for instance, may include an inductive element formed as a flexible loop that is configured to at least partially surround the peripheral device and form a communicative coupling between the peripheral device and the computing device, such as to charge the peripheral device, transfer data, and so forth. In this way, efficiency of charging using the loop may increase over conventional techniques and flexibility of the loop may be used to limit interference of the loop with a user when not in use, e.g., may lay flat. Additionally, this flexibility may serve as a basis to control power output to the loop and thus improve efficiency of the device as further described in the following.

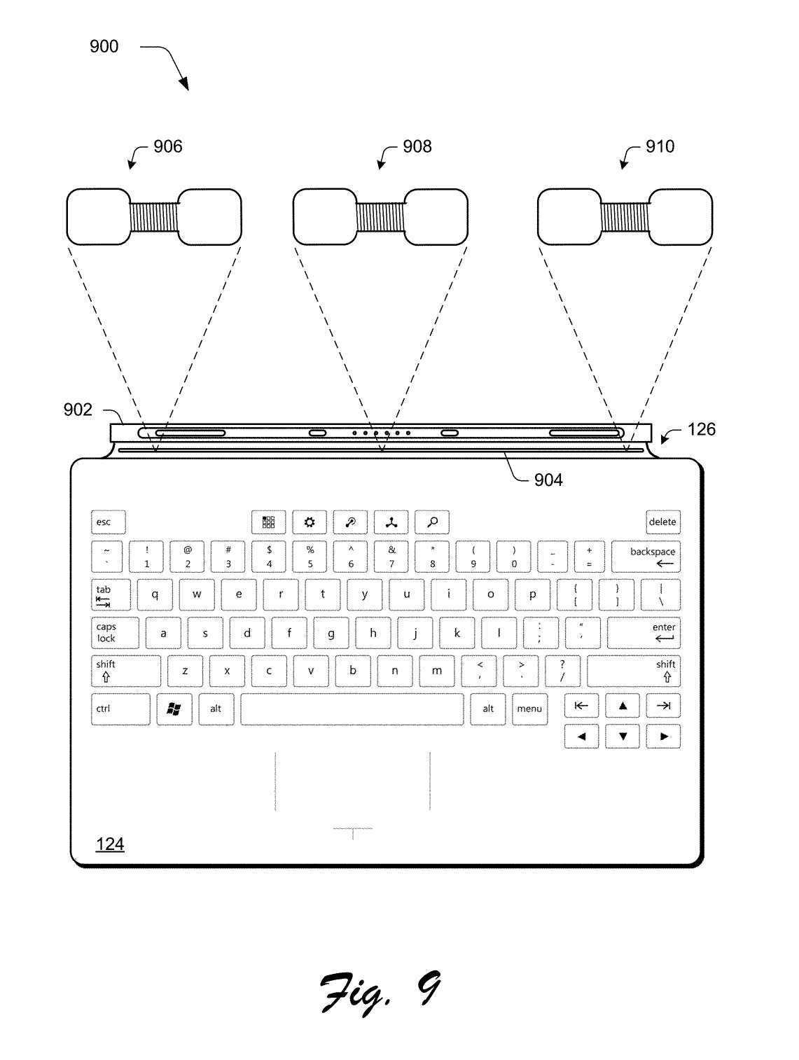

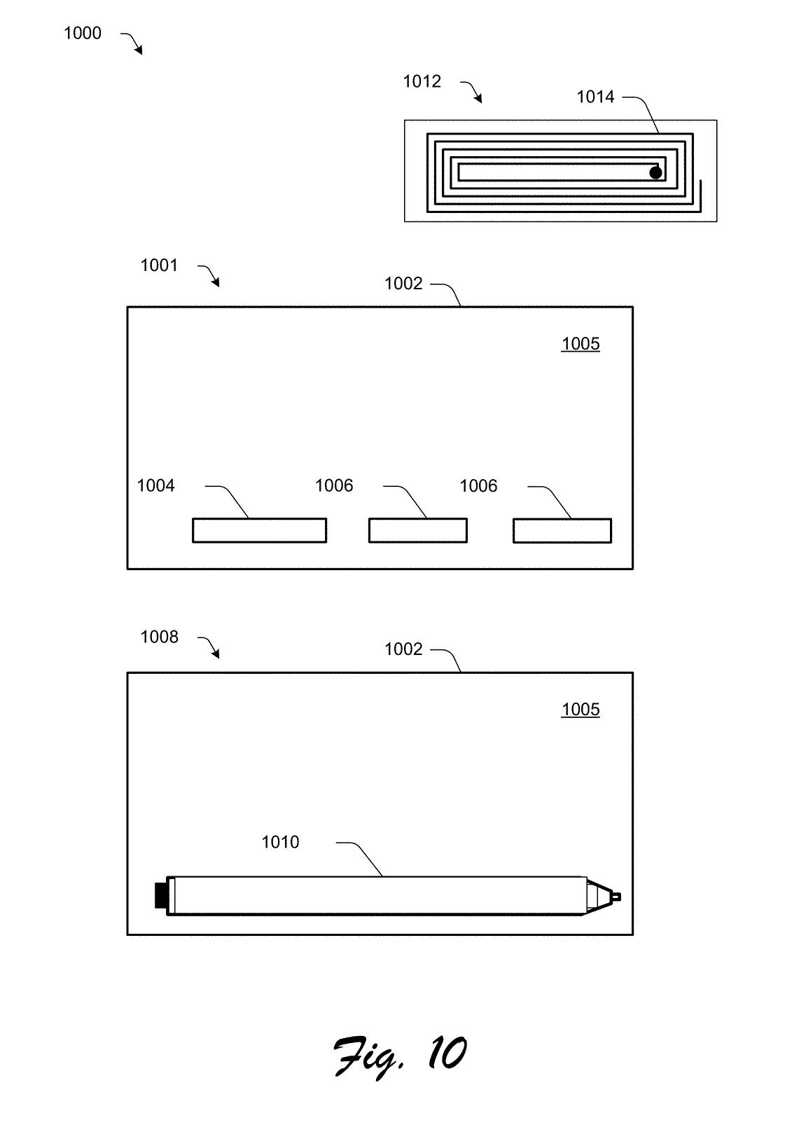

An inductive element is also described that may be utilized to support rotationally invariant induction. The inductive element, for instance, may be shaped to mimic a barbell such that flux lines of the inductive element have a shape that mimics a donut. In this way, the inductive element may be utilized to support induction by a device without having to rotate the device in a particular orientation, such as for use by a stylus, a flexible hinge of a peripheral device (e.g., keyboard) or computing device, and so on. Further discussion of these features may be found in relation to FIGS. 8 and 9.

In one or more implementations, the peripheral retention device includes an inductive element comprising one or more inductive coils integrated into a surface of the peripheral retention device. The peripheral retention device also includes a peripheral securing element configured to secure a peripheral device to the surface of the peripheral retention device to form a communicative coupling with the peripheral device via the one or more inductive coils. In some cases, the peripheral securing element includes one or more magnets configured to secure the peripheral device to the peripheral retention device such that the one or more inductive coils of the peripheral retention device are aligned with one or more corresponding inductive coils of the peripheral device.

In one or more implementations, a ping signal is communicated via one or more inductive coils of a peripheral retention device integrated within a device, and it is determined whether a reply signal is received from a peripheral device secured to the peripheral retention device. In response to a determination that the reply signal is received, a first power mode is utilized in which a first amount of power is provided to the inductive coils of the peripheral retention device, and in responsive to a determination that the reply signal is not received, a second power mode is utilized in which a second amount of power is provided to the inductive coils of the peripheral retention device that is less than the first amount of power.

In the following discussion, an example environment is first described that may employ the techniques described herein. Example mechanisms are also described which may be performed in the example environment as well as other environments. Consequently, use of the example mechanisms is not limited to the example environment and the example environment is not limited to use of the example mechanisms.

Example Environment

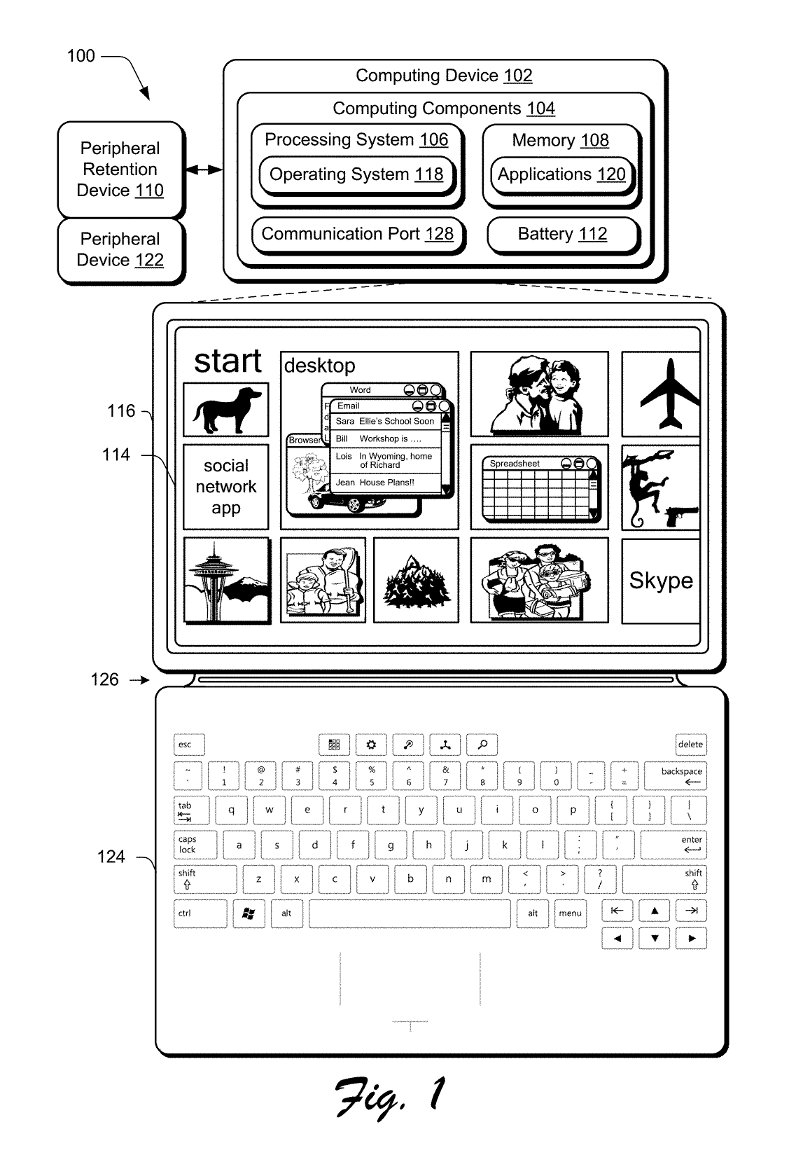

FIG. 1 is an illustration of an environment 100 in an example implementation that is operable to employ techniques described herein. The illustrated environment 100 includes a computing device 102 having a plurality of computing components 104 that are implemented at least partially in hardware. Illustrated examples of these computing components 104 include a processing system 106 and a computer-readable storage medium that is illustrated as a memory 108, a peripheral retention device 110, battery 112, and display device 114 that are disposed within and/or secured to a housing 116.

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles).

The computing device 102 is further illustrated as including an operating system 118. The operating system 118 is configured to abstract underlying functionality of the computing device 102 to applications 120 that are executable on the computing device 102. For example, the operating system 118 may abstract the computing components 104 of the computing device 102 such that the applications 120 may be written without knowing “how” this underlying functionality is implemented. The application 120, for instance, may provide data to the operating system 118 to be rendered and displayed by the display device 114 without understanding how this rendering will be performed, may receive inputs detected using touchscreen functionality of the display device 114, and so on. The operating system 118 may also represent a variety of other functionality, such as to manage a file system and user interface that is navigable by a user of the computing device 102.

The computing device 102 may support a variety of different interactions. For example, the computing device 102 may include one or more hardware devices that are manipulable by a user to interact with the device, which may include peripheral devices 112 (e.g., cursor control device such as a mouse, stylus), a keyboard 124 communicatively and physically coupled to the computing device 102 using a flexible hinge 126, and so on.

Peripheral devices 122 such as a stylus may be lost in some instances by a user because the device is not physically attached to the computing device 102, especially in handheld (i.e., mobile) configurations of the computing device 102. However, conventional techniques that were utilized to secure the stylus to the computing device 102 could consume inordinate amounts of room within a housing 116 (e.g., by internal slot is used to store and retain the stylus through friction or through a push-push type mechanism), interfere with a user's interaction with a device (e.g., a lanyard), and so forth. Accordingly, the peripheral retention device 110 may be configured to secure the peripheral device 122 to the housing 116 in a manner that does not interfere with a user's interaction with the computing device 102.

Further, the peripheral retention device 110 may also be configured to support a communicative coupling with a communication port 128 of the computing device, such as to transfer power to charge the peripheral device 122, communicate data between the peripheral device 122 and the computing device 102, and so on. For example, it is now common practice to use a stylus to draw on the touch enabled displays of laptops and tablets. In some instances, the stylus may be configured to consume power to support this interaction.

In one such instance, an active stylus is configured to improve on detectability of a passive stylus by emitting signals that are received by touchscreen functionality of the display device 114 to improve spatial resolution of a tip of the stylus. The tip may even be located when it is hovering above a surface of the display device 114. The active stylus may also consume power to support Bluetooth® communication, button activated features, and so on. Other features that may consume power include detection of stylus angle and rotation the pen tip to adjust ink thickness, haptic or acoustic feedback of pen function or notifications, support use as a laser pointer for meeting room collaboration, include a text display for status and notifications, communicate device status, email, and others notification with always on communication and LED indicators, support audio recording and data storage, and so forth. This power may be supplied by rechargeable storage included as part of the peripheral device, e.g., a battery or super capacitor.

Conventional techniques utilized to provide power to the rechargeable storage may have a variety of drawbacks. For example, use of a micro USB connector by a stylus generally involves placement of the connector on an end of the stylus opposite the tip. Charging the stylus by plugging it into a USB port also necessitates either having an additional USB cable or plugging directly into a tablet or laptop. This may involve stylus disassembly, a common USB port across the product line, and has a risk of product damage as it is cantilevered while charging.

Another conventional technique involves the addition of conductive charging points to an outside of the stylus to directly connect it to charging points on the device that supplies power, e.g., a computing device. This direct galvanic charging technique, however, may interfere with the industrial design, exposes the contact points to wear and damage, and may be restricted in its alignment to connect the stylus contacts to a power source in a predictable manner.

Accordingly, the peripheral retention device 110 may be configured to support wireless inductive charging. For example, the peripheral device 122 may include a receiving coil inside which, when coupled to an external, powered, primary charging coil of the peripheral retention device 110, form the secondary of a transformer. This air gap transformer is what sends power into the peripheral 122 and thereby support a communicative coupling between the peripheral device 122, the peripheral retention device 110, and the computing device 102 which may also be utilized to communicate data between the devices.

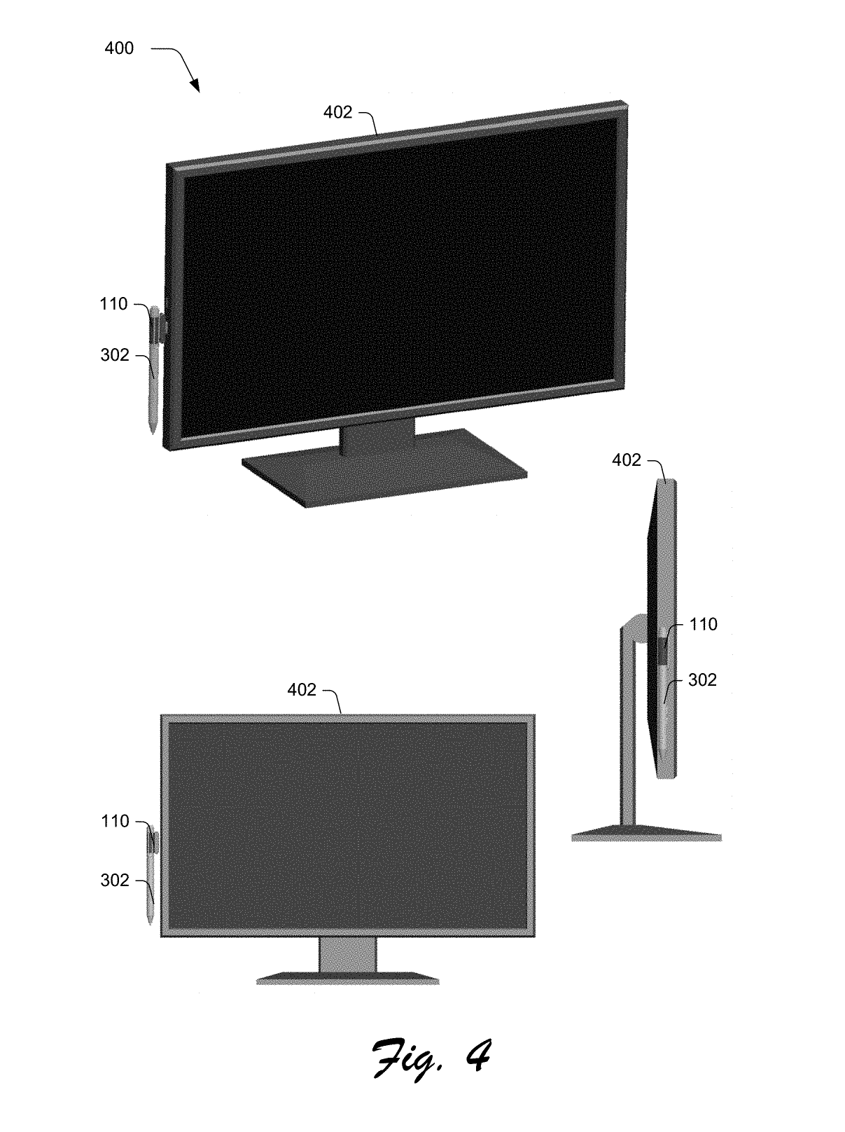

Although the peripheral retention device 110 is illustrated as connected to a communication port 128 of the computing device 102, the peripheral retention device 110 may be coupled to a variety of other devices, such as an external battery device (e.g., for mobile charging), an external charging device (e.g., to plug into a wall socket), a communication port 128 on the input device 124, a monitor as shown in FIG. 4, and so on.

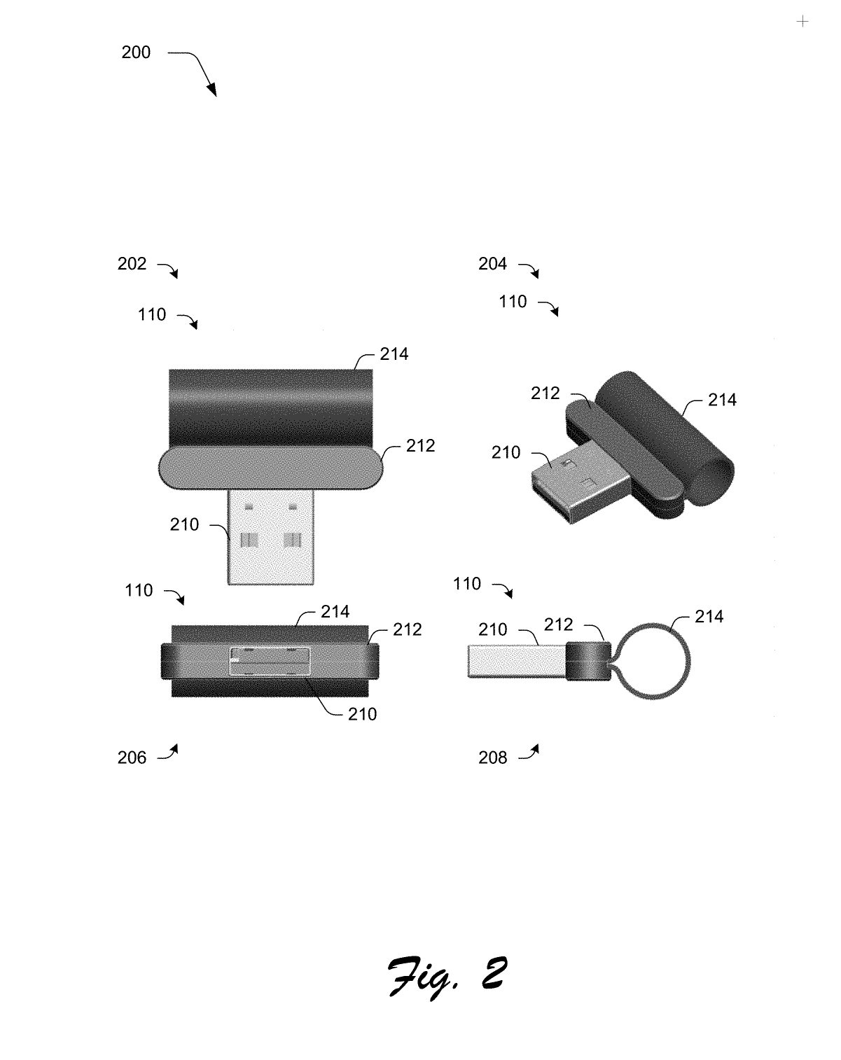

FIG. 2 depicts an example implementation 200 showing different views of an example of a peripheral retention device 110 of FIG. 1. This example implementation includes top 202, perspective 204, front 206, and side 208 views of an example of a peripheral retention device 110. The peripheral retention device 110 includes a plug 210 that is configured to be secured to a communication port 128 of a device. The plug 210 in this example is illustrated as being formed in compliance with a Type A Universal Serial Bus (USB) but it should be readily apparent that other configurations are also contemplated, such as in compliance with other types of USB ports (e.g., Type B, Mini-AB, Mini-B, Micro-AB, Micro-B, Type C), Thunderbolt® communication ports, and so on. Other examples are also contemplated, such as use without a plug, e.g., permanently mounted to the computing device.

The peripheral retention device 110 also includes a peripheral securing portion 212 connected to the plug and configured to removably engage a peripheral device, which in this example is performed using a flexible loop 214. The flexible loop 214, for example, may be configured to flex and stretch to retain a peripheral device, such as a stylus, within an interior of the flexible loop 214.

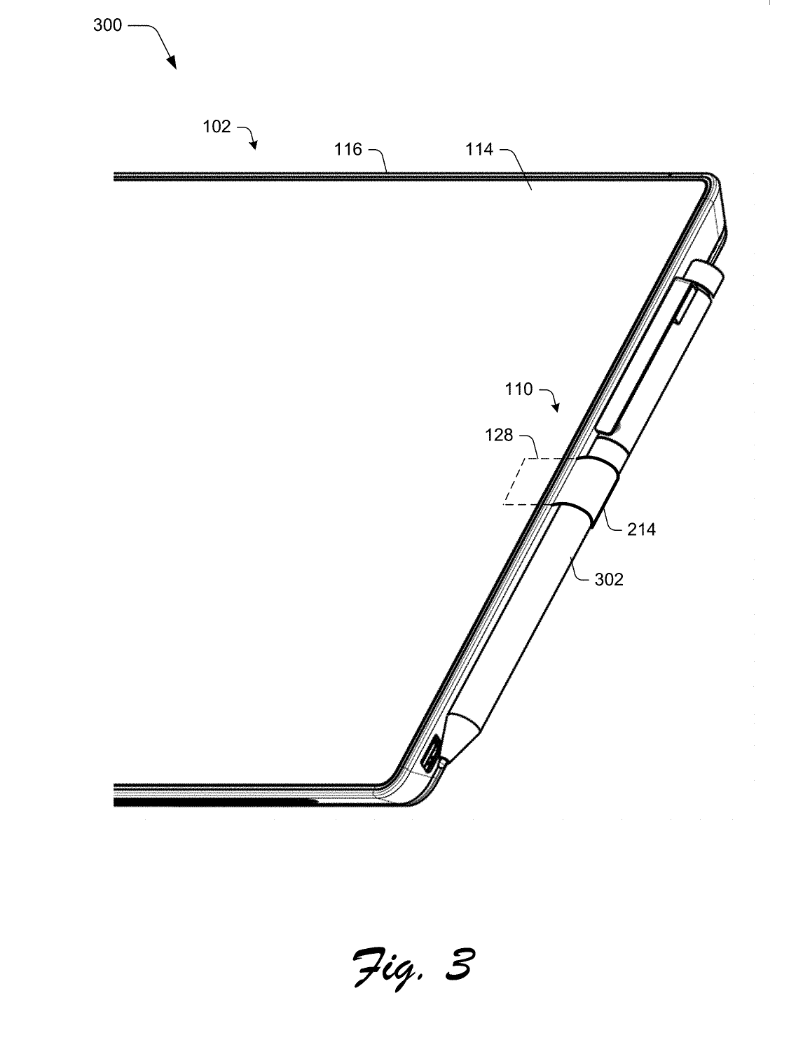

As shown in an example implementation 300 of FIG. 3, for instance, the peripheral retention device 110 may be secured to a communication port 128 which is illustrated in phantom. An example of a peripheral device 122 of FIG. 1 is illustrated as a stylus 302 that is retained within the flexible loop 214 and thus secured to the computing device 102.

In the illustrated example, the flexible loop 214 assumes a complementary shape of the peripheral being secured through use of a flexible material, such as a fabric, rubber, or elastic material. Other examples are also contemplated including examples in which the peripheral retention device 110 utilizes techniques that are not flexible, e.g., is molded to conform to an outer surface of a peripheral device 122 to be retained.

The flexible loop 214 may also be configured to provide a biasing force to secure the peripheral. For example, formation as a flexible and stretchable loop (e.g., elastic) may bias the peripheral toward the housing 116 and thereby retain the peripheral against the housing 116. Other examples are also contemplated.

The use of a flexible material to form the flexible loop 214 may also support a variety of other functionality. For example, the flexible loop 214 may be configured to “flatten” as shown in FIG. 11. The computing device 102, for instance, may be placed on a surface which causes the flexible loop to flatten against the surface when a stylus 302 is not retained by the device. Additionally, this may permit the stylus 302 to “rotate up” away from the surface such that the computing device 102 may lay flat against the surface. In this way, the peripheral retention device 110 does not interfere with a user's interaction with the computing device 102.

FIG. 4 depicts another example implementation 400 in which the peripheral retention device 110 of FIG. 3 is used to secure the stylus 302 to a standalone display device. In this example, the peripheral retention device 110 is secured to a communication port of a standalone display device 402. In this way, the stylus 302 may be secured “out of the way” when not in use. Further, the stylus 302 may also be charged through use of an inductive element formed as part of the peripheral retention device 110, further discussion of which may be found in the following and is shown in a corresponding figure.

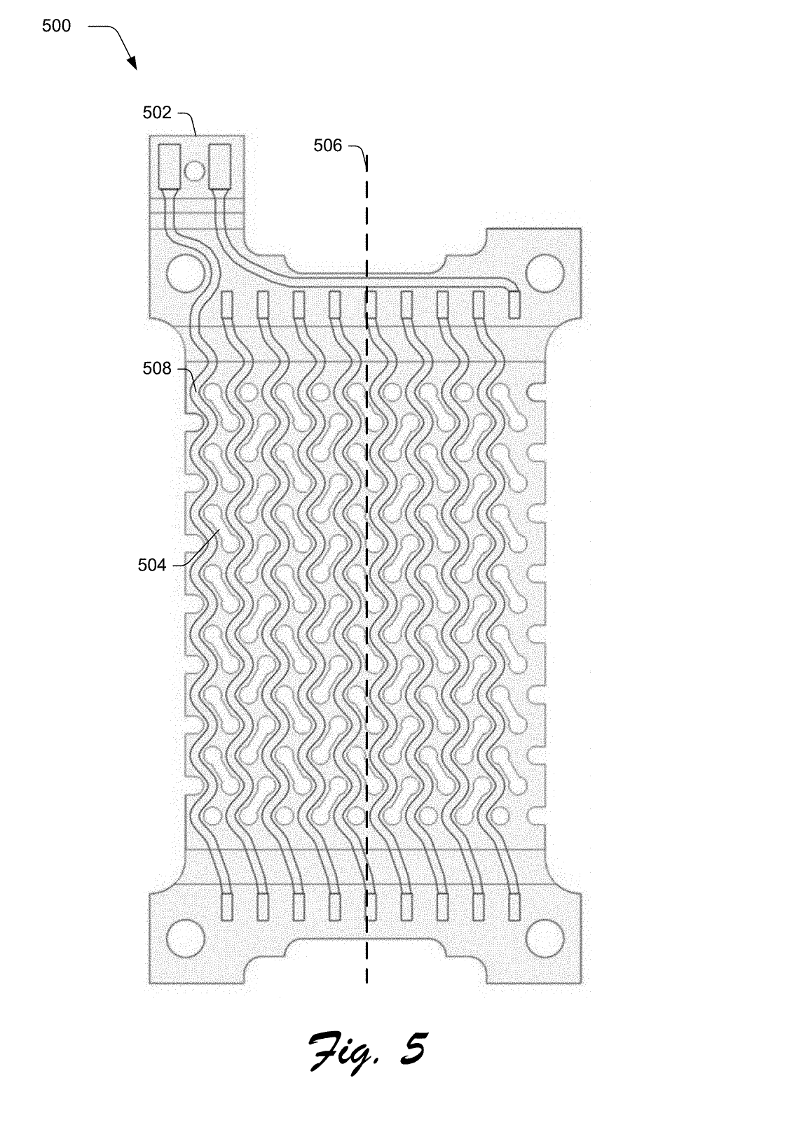

FIG. 5 depicts an example implementation 500 showing an inductive element 502 of a peripheral retention device 110 of FIG. 3. The inductive element 502 in this example is configured to be both flexible and stretchable. This is performed by including elliptical perforations 504 in this example that have a generally barbell shape in which ends of the perforations 504 have a greater width than a midsection of the perforations 504. Other perforation shapes are also contemplated.

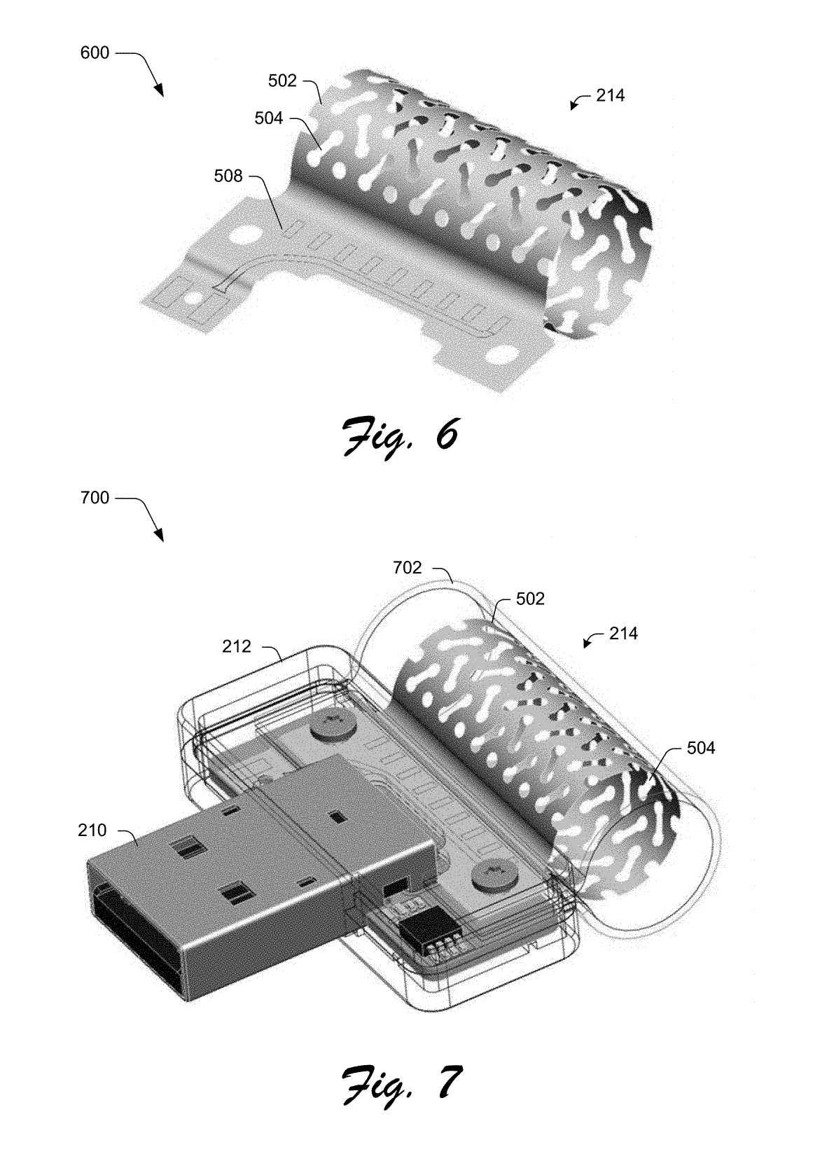

The perforations 504 are also arranged at a generally forty-five degree angle in relation to a longitudinal axis 506 that is configured to form a bend to assume a cylindrical shape as shown in FIG. 6 and support stretching in both x and y directions. Additionally, the perforations 504 have an alternating arrangement of angles, one to another, in relation to the axis 506.

The inductive element 502 also includes traces 508 that are configured to carry an electrical current to form the inductive connection. By implementing the inductive element 502 as a primary coil on a substrate (e.g., polyimide substrate) with a sinusoidal trace pattern and elliptical perforations 504, the inductive element 502 becomes both flexible and stretchable to allow the flexible loop to collapse when not used and to resist damage during the insertion and removal of a peripheral device 122 such as a stylus 302.

FIG. 6 depicts an example implementation 600 in which the inductive element 502 of FIG. 5 is bent to form a flexible loop 502. As illustrated the perforations 504 of the inductive element 502 permit bending to form a loop. The perforations 504 may also permit stretching such as to provide an elastic force to retain a peripheral device 122 within the flexible loop 216 as previously described. The traces 508 are configured to form an inductive electrical field within an interior of the flexible loop 214 thereby forming an inductive communicative coupling.

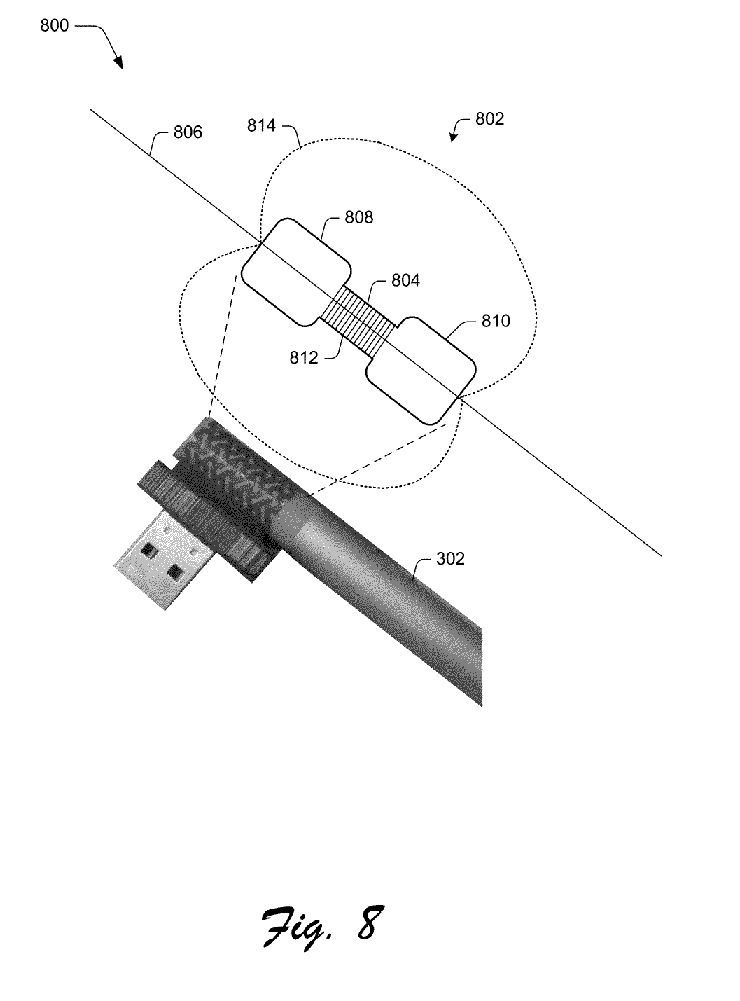

FIG. 7 depicts an example implementation 700 in which the inductive element 502 of FIG. 6 is installed as part of the peripheral retention device 110 of FIG. 2. In this example, the inductive element 502 (e.g., primary coil) is configured as a flexible loop that is surrounded by a fabric 702. The inductive element 502 is communicatively coupled to the plug 210 as part of the peripheral securing portion 212 and thus may receive electricity from a communication port 128 of a device as previously described.

Conventionally, a primary coil of an air gap transformer for accessory charging is constructed flat as a “charging pad”. However, wrapping a primary coil around the secondary coil increases efficiency in a transfer of power from the charger to the accessory, e.g., by over seventy-seven percent. Testing of this prototype (FIG. 1) has yielded an efficiency of up to 77% and indicates that it is feasible to fully charge a 160 mA Lithium rechargeable stylus in approximately an hour and approximately half an hour for a super-capacitor cell.

FIG. 8 depicts an example implementation 800 of a secondary coil usage by a peripheral device 122 of FIG. 1 for form an inductive communicative coupling between devices. Conventional secondary coils of air gap transformers are typically three centimeters by four centimeters and larger, making them difficult to place in peripheral devices 122 such as a stylus 302.

Accordingly, an inductive coil 802 in this example is formed from a single ferrous element, which in this example is a single integral piece having a middle portion 804 having a diameter about an axis 806 that is less than a diameter of opposing ends 808, 810 of the single ferrous element along the axis 806.

A coil 812 is wrapped around the middle portion 804 such that the coil 812 and the single ferrous element form an inductive coil 802 that is substantially rotationally invariant around the axis. The inductive coil 802 may include an open tunnel (e.g., similar to a pipe) running through a longitudinal access, which may be used to permit wires to be run through the tunnel to support communication from one end of the stylus to the other. The diameter of the opposing ends 808, 810 allow the ferrous material to extend to an edge of a housing of the stylus 302 and the cylindrical shape makes coupling rotationally invariant by forming flux lines 814 in a shape that mimics a donut as illustrated. This secondary coil assembly can be made small and dense enough to fit well in a stylus 302 while transferring enough power to charge an internal battery in any rotational position.

Inductive coupling between primary and secondary coils is sensitive to the distance between the coils. The smaller the coils, the faster this loss of coupling occurs. Further, the stylus 302 may typically be stored in a way that does not constrain a longitudinal rotational position of the stylus. Therefore, by using a shape that mimics a dumbbell as shown in FIG. 8, the inductive coil 802, in this instance operating as a secondary coil, may minimize a distance to the primary coil of the peripheral retention device 110 while having good coupling at any longitudinal rotational angle. Although described as a secondary coil in this example, the inductive coil 802 may also function as a primary coil as further described below.

FIG. 9 depicts an example implementation 900 in which an inductive coil of FIG. 8 is configured to operate as a primary coil in an air gap transformer arrangement. In this example, a connection portion 902 of the input device 124 is shown that is configured to provide a communicative and physical connection between the input device 124 and the computing device 102. The connection portion 902 as illustrated has a height and cross section configured to be received in a channel in the housing of the computing device 102, although this arrangement may also be reversed without departing from the spirit and scope thereof.

The connection portion 902 is flexibly connected to a portion of the input device 104 that includes the keys through use of the flexible hinge 126. Thus, when the connection portion 202 is physically connected to the computing device the combination of the connection portion 902 and the flexible hinge 126 supports movement of the input device 124 in relation to the computing device 102 that is similar to a hinge of a book.

The flexible hinge 126 in this example includes a mid-spine 904 having a plurality of inductive coils 906, 908, 910 that are configured similar to the inductive coil 902 of FIG. 8 but in this instance operate as primary coils of an air gap transformer. Thus, to form a communication coupling between the input device 124 (and thus the computing device 102 of FIG. 1) to a stylus 302 of FIG. 3 or other peripheral device 122 in this example a user may rest the stylus 302 against the flexible hinge or secure it thereto using a pen clip of the stylus 302 to cause an inductive coupling. This may be utilized to charge the stylus, transfer data (e.g., to authenticate the peripheral device 122), and so on as previously described. Further, flux flow lines may also support a rotationally invariant shape such that the flexible hinge 126 may move yet still support the communicative coupling.

In one or more implementations, peripheral retention device 110 is implemented with an inductive element including one or more inductive coils integrated into a surface of the peripheral retention device. The peripheral retention device also includes a peripheral securing element configured to secure a peripheral device (e.g., a stylus) to the surface of the peripheral retention device to form a communicative coupling with the peripheral device via the one or more inductive coils.

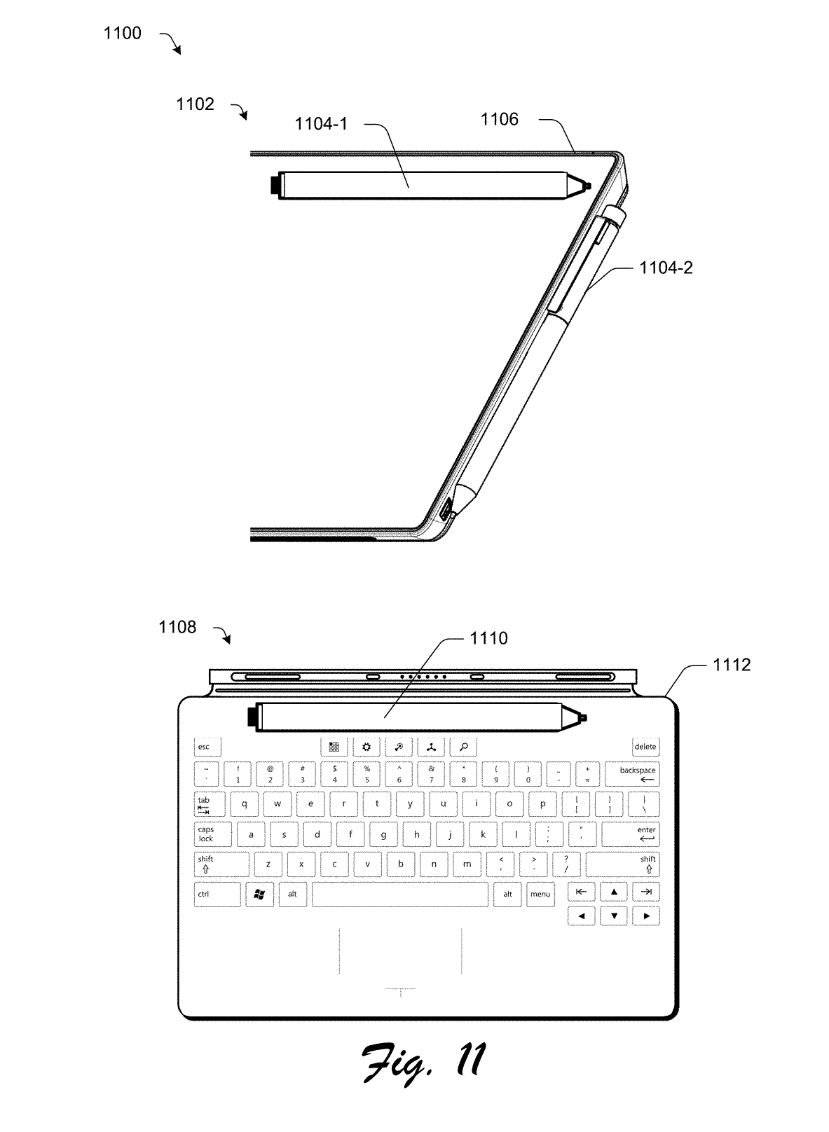

As an example, consider FIG. 10 which illustrates an example implementation 1000 of a peripheral retention device in accordance with one or more implementations. In this example, at 1001, a peripheral retention device 1002 includes one or more inductive elements 1004 integrated into a flat surface 1005 of the peripheral retention device 1002. Notably, the peripheral retention device may be integrated into a variety of different types of surfaces, such as flat surfaces, curved surfaces, rounded surfaces, and so forth. The peripheral retention device also includes a peripheral securing element, which in this example is illustrated as one or more magnets 1006, that is configured to secure a peripheral device to the flat surface 1005 of the peripheral retention device 1002 to form a communication coupling with the peripheral device. For example, at 1008, the peripheral retention device 1002 is illustrated with a peripheral device 1010, illustrated as a stylus, magnetically coupled to the peripheral retention device 1002 via the magnets 1006. Thus, instead of using a flexible loop to secure the peripheral device 1010, the peripheral retention device 1002 enables the peripheral device 1010 to be placed on the flat surface 1005 of the peripheral retention device 1002. As described throughout, peripheral retention device 1002 may be configured to secure a variety of different types of peripheral devices 1010, including by way of example and not limitation, a stylus, a mouse, a dial, a head-mounted display, headphones, ear buds, a smartwatch, a smart band (e.g., fitness band), and so forth.

In one or more implementations, the inductive element 1004 is implemented as one or more inductive coils integrated into the flat surface of the peripheral retention device. For example, at 1012, a blown-up view of inductive element 1004 is illustrated as including one or more inductive coils 1014. The inductive coils may be configured as flat traces configured to carry an electrical current to form an inductive connection with peripheral device 1010. For example, the inductive coils 1014 may be printed on a two-layer FPC of the peripheral retention device 1002, or on any type of non-metal material of the peripheral retention device 1002, such as plastic, a printed circuit board, glass, and so forth. In one or more implementations, the inductive coils 1014 include traces on any material and a ferrite core material. In some cases, the ferrite core material is approximately 0.1 millimeters thick, but may also be any other thickness. Unlike the “dumbbell” style inductive coil illustrated at FIGS. 8 and 9, the inductive coils 1014 are flat coils which face each other as parallel plates. The ferrite core material replaces the dumbbell or barbell shape core material, and acts as both a flux concentrator and a shield to contain the flux from other electron parts, or from metal surfaces which may create loss due to eddy current or skin effect. Notably, the inductive coils 1014 are small. In this example, the inductive coils include 6 traces or “turns”. However, in some cases, the inductive coils 1014 may be implemented with as few as one or two traces.

The ability to provide small inductive coils 1014 on a flat surface enables the peripheral retention device 1002 to be thin. Thus, the peripheral retention device may be integrated at a variety of different locations on a variety of different types of devices with thin form factors. By way of example and not limitation, the peripheral retention device 1002 may be implemented on a cover of a laptop, an input device (e.g., a keyboard), on the back of a tablet device, and so forth. In some cases, the peripheral retention device 1002 is removable from the device. Alternately, the peripheral retention device 1002 may be permanently integrated into the device.

When the peripheral device 1010 is secured to the peripheral retention device 1002 (e.g., via magnets 1006), the inductive coils 1014 enable a communicative coupling with the peripheral device 1010. The communicative coupling enabled by the inductive coils 1014 is configured to charge the peripheral device 1010 using power received from the device to which the peripheral retention device is integrated or attached. Notably, the charge rates needed for peripheral device 1010 is low, which enables the use of small inductive coils 1014.

Unlike some conventional inductive charging devices in which a separate communication protocol is used for communication (e.g., Bluetooth), the communicative coupling enabled by the one or more inductive coils 1014 is configured to support two-way communication of data using induction between the device and the peripheral device 1010. Such two-way communication can be used to support firmware updates to the peripheral device, peripheral device detection, power reporting and management, and so forth.

In this example, magnets 1006 are configured to secure the peripheral device 1010 to the flat surface 1005 of the peripheral retention device 1002 such that the one or more inductive coils 1014 of the peripheral retention device 1002 are aligned with one or more corresponding inductive coils (not pictured) of the peripheral device 1010. Notably, due to the small size of inductive coils 1014, precise alignment is necessary to enable the transfer of power and data. Thus the magnets 1006 are strong enough to ensure that the peripheral device 1010 perfectly aligns with the inductive coils 1014. For example, the magnets 1006 may enable alignment with a degree of accuracy of plus or minus one millimeter.

In one or more implementations, the peripheral securing element may be implemented without the use of magnets 1006. For example, in some cases, the peripheral securing element may be implemented as a tray or indent in the peripheral retention device 1002 in which the peripheral device 1010 can rest. In this case, the tray may be precisely the same size as the peripheral device 1010 such that the inductive coils 1014 are perfectly aligned with the peripheral device 1010 when the peripheral device 1010 is placed in the tray.

Notably, integrating the inductive coils into the flat surface 1005 of the peripheral retention device 1002 provides a variety of different benefits, such as seamless charging, simultaneous charging of both the peripheral device and the device due to the low power of the inductive coils 1014, and a smaller charging footprint enabled by the magnets holding the peripheral device in place.

In one or more implementations, the inductive coils 1014 of the peripheral retention device 1002 utilize a modified version of an interface standard developed by the Alliance for Wireless Power (A4WP) in order to enable the transfer of data and power to the peripheral device 1010. The modified A4WP interface enables a smaller overall design (by eliminating the Bluetooth circuitry) while retaining high speed bi-directional communication. In this implementation, a peripheral device can be charged at a 0.75 C rate, such that a three-minute charge provides 30 minutes of battery life for the peripheral device, while a full charge can be completed in under 90 minutes. In addition, the modified A4WP interface enables 50 kbps two-way magnetic communication with the peripheral device 1010. Such two-way magnetic communication can be used to support firmware updates to the peripheral device, peripheral device detection, power management, and so forth, without the use of a separate communication protocol such as Bluetooth.

FIG. 11 illustrates example implementations 1100 in which a peripheral device is secured to a flat surface of the peripheral retention device integrated into the housing of a device. At 1102, a stylus is shown as being secured to a flat surface of the peripheral retention device, which is integrated within the housing of a computing device. This example shows two different positions at which the peripheral device could be positioned. A first peripheral device 1104-1 and a second peripheral device 1104-2 are each shown as being secured to a flat surface of the peripheral retention device, which is integrated within the housing of a computing device 1106, via one or more magnets (not pictured). In this example, peripheral device 1104-1 is shown as being secured to the back side of a tablet device, while peripheral device 1104-2 is shown as being secured to a side edge of the tablet device. Notably, peripheral device 1104-2 is shown as being secured to a peripheral retention device which is integrated along the side of a narrow edge of the tablet device. This implementation is similar to the implementation depicted in FIG. 3, but the flexible loop of FIG. 3 is replaced with the one or more magnets of the peripheral retention device 1002. Notably, the peripheral retention device can be implemented in a variety of different locations on different types of devices, such as the back of a tablet device, the side of a tablet device, the cover of a laptop device, an input device, or a display device, to name just a few. As discussed with regards to FIG. 10, above, when secured to device 1106, inductive coils of the peripheral retention device enables the transfer of data and power between device 1106 and peripheral device 1104-1 or 1104-2.

At 1108, a peripheral device 1110, illustrated as a stylus, is secured to a flat surface of the peripheral retention device, which is integrated within the housing of an input device 1112, via one or more magnets. In this example, the input device 1112 is illustrated as a keyboard device. However, as discussed throughout, the peripheral retention device may be integrated into a variety of different devices. As discussed with regards to FIG. 10, above, when secured to input device 1112, inductive coils of the peripheral retention device enables the transfer of data and power between input device 1112 and peripheral device 1110.

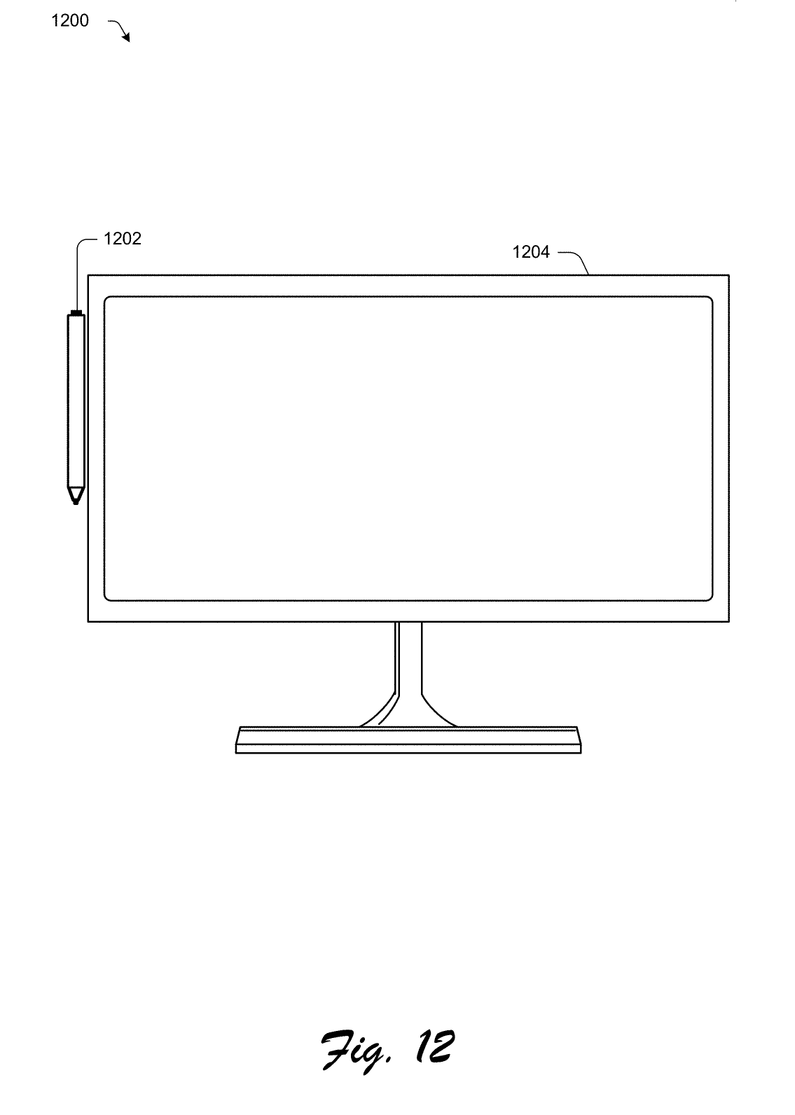

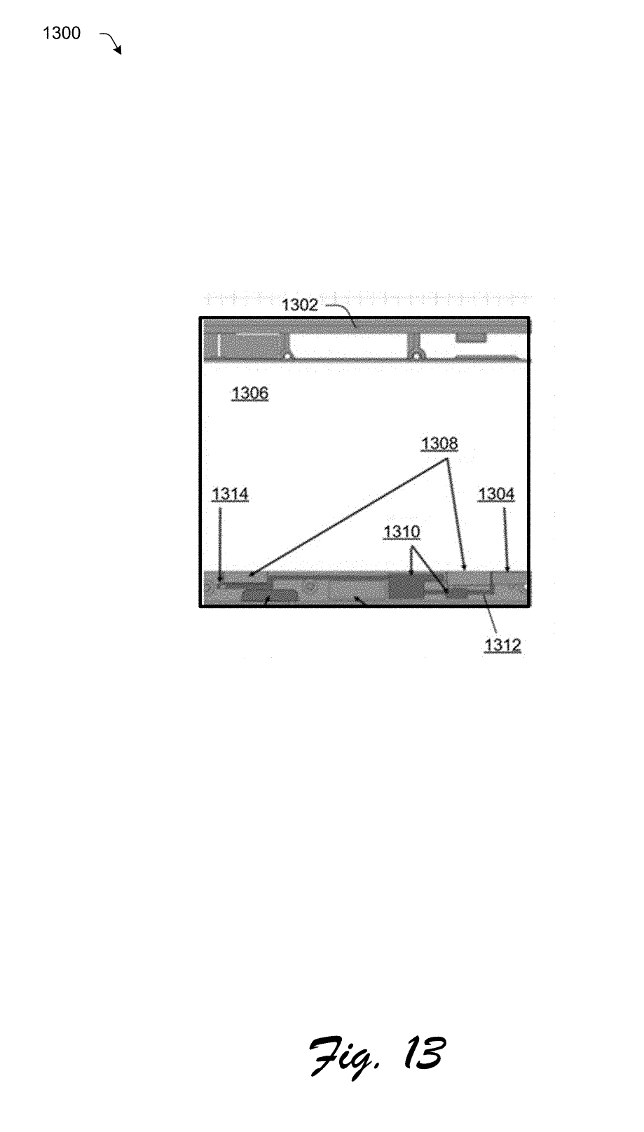

FIG. 12 illustrates another example implementation 1200 in which a peripheral device is secured to a flat surface of the peripheral retention device integrated into the housing of a device. In this example, a peripheral device 1202, illustrated as a stylus, is secured to a flat surface of the peripheral retention device, which is integrated into the side of a standalone display device 1204, via one or more magnets (not pictured). As discussed with regards to FIG. 10, above, when secured to device 1204, inductive coils of the peripheral retention device enables the transfer of data and power between device 1204 and peripheral device 1202.

Notably, FIGS. 11 and 12 provide just a few ways in which the peripheral retention device 1002 can be integrated into a device. In one or more implementations, the peripheral retention device may be integrated into the glass surface of a display screen. In this implementation, the inductive coils and magnets are positioned behind the glass of the display screen, such that the peripheral device can be secured to the display screen to enable the transfer of data and power as described throughout.

FIG. 13 illustrates an example implementation 1300 of a peripheral retention device in accordance with one or more implementations. In this example, a peripheral retention device 1302 includes one or more inductive coils 1304 integrated into a flat surface 1306 of the peripheral retention device 1302. Notably, the small size of the inductive coils 1304 enables the inductive coils to be placed on an outer edge of the peripheral retention device 1302. The peripheral retention device also includes magnets 1308 which are configured to secure a peripheral device to the flat surface 1306 of the peripheral retention device 1302 to form a communicative coupling with the peripheral device. In this example, the peripheral retention device further includes a charging circuit 1310, and a long, thin FPC 1312 which routes the inductive coils 1304 to a lower combo flex 1314.

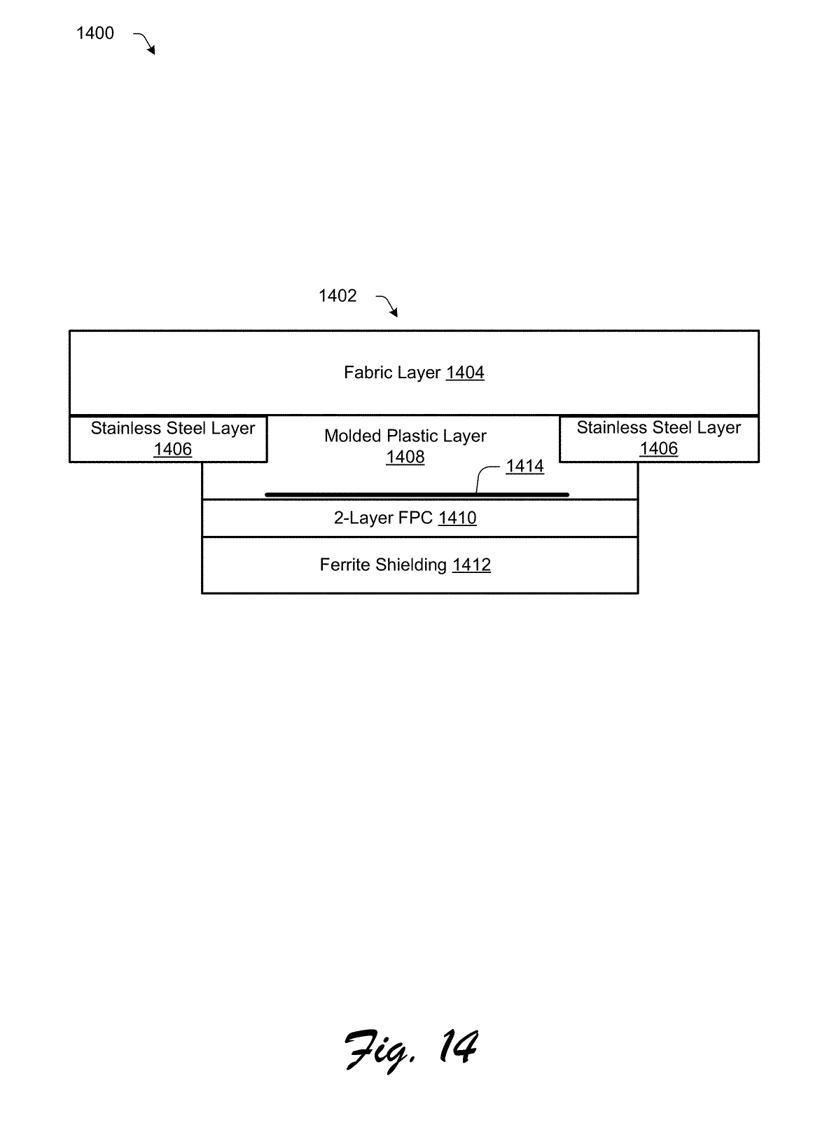

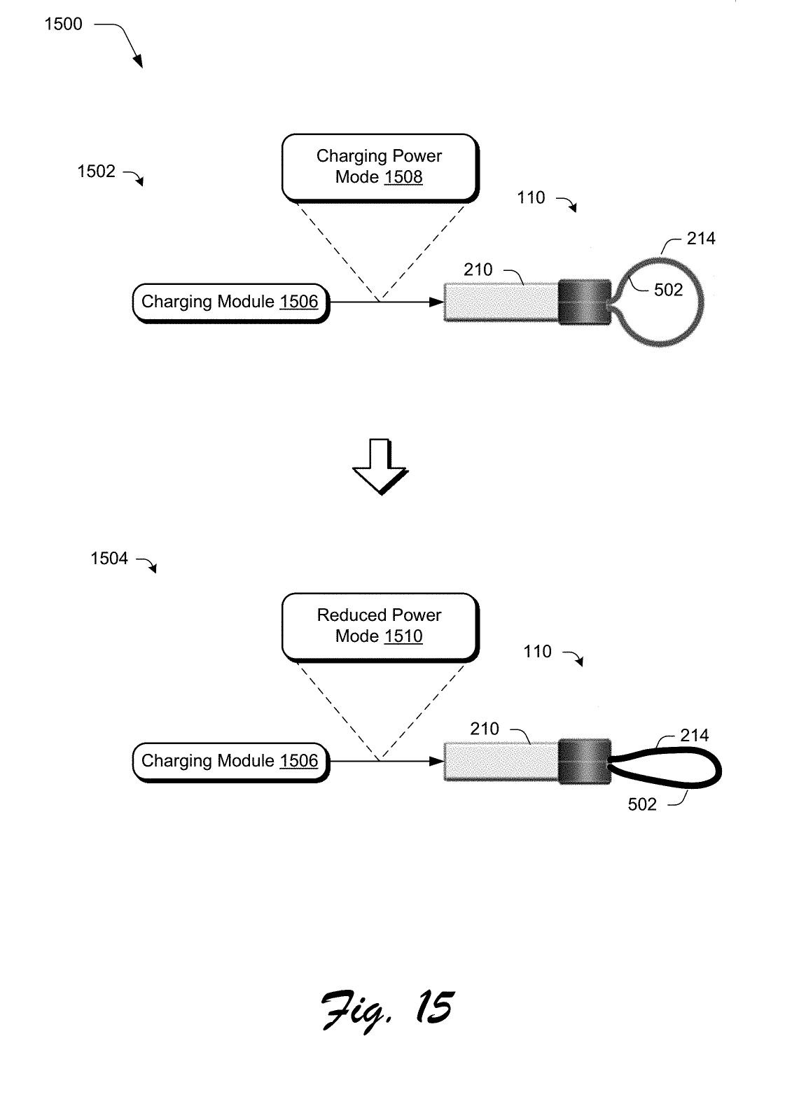

FIG. 14 illustrates an additional example implementation 1400 of a peripheral retention device in accordance with one or more implementations. In this example, a mechanical stack-up view of a peripheral retention device 1402 is illustrated. The peripheral retention device 1402 includes a fabric layer 1404 on a top surface of the peripheral retention device 1402. Directly below the fabric layer 1404 is a stainless steel layer 1406 with a window, in which a molded plastic layer 1408 is placed. Below the molded plastic layer 1408 is a 2-layer flexible printed circuit (FPC) 1410 and ferrite shielding 1412.

In this example, inductive coils 1412 are printed as traces on the 2-layer FPC. Notably, the total Z-thickness of the peripheral retention device 1402, in this example, may be less than 0.80 millimeters. For example, the fabric layer 1404 may be approximately 0.2 millimeters, the molded plastic layer 1408 may be approximately 0.35 millimeters, the 2-layer FPC 1410 may be approximately 0.05 to 0.10 millimeters, and the ferrite shielding 1412 may be approximately 0.1 millimeters. The traces of the inductive coils 1412 may be just 0.03 millimeters or less.

FIG. 15 depicts an example implementation 1500 in which power modes are utilized to control an amount of power provided to the inductive element 502 of the peripheral retention device 110. This example implementation is shown using first and second stages 1502, 1504. A charging module 1506 is illustrated at each of the stages that is representative of functionality to control an amount of power provided by the peripheral retention device 110 to the inductive element 502. The charging module 1506, for instance, may be incorporated as part of the peripheral retention device 110 itself, a device to which the peripheral retention device 110 is attached (e.g., the computing device 102), and so forth. In this example, peripheral retention device 110 is illustrated as a flexible loop 214. However, the charging module 1506 may also be implemented to control the amount of power provided by the peripheral retention device 110 to the inductive element 502, when the inductive element 502 is implemented as inductive coils integrated directly into a flat surface of the peripheral retention device (e.g., as discussed with regards to FIGS. 10-14 above).

At the first stage 1502, a charging module 1506 detects that the flexible loop 214 and corresponding inductive element 502 is arranged as a loop, such as the insertion of a pen. This may be determined by measuring inductance of the inductive element 502 by the charging module 1506. The ferrite secondary receiving coil inside the pen causes a significant increase in the inductance of the inductive element 502. Thus, the charging module 1506 may determine that the inductive element 502 is configured to support a communicative coupling and may provide a level of power sufficient to charge a peripheral device 122, e.g., power mode 1508.

At the second stage 1504, however, the charging module 1506 detects that the flexible loop 214 and corresponding inductive element 502 has collapsed. This may be detected by the charging module 1506 by detecting that the inductive element 502 exhibits low inductance. For example, opposing sides of the charging module 1506 may cause a short when disposed closely to each other, such as when the flexible loop 214 collapses or flattens.

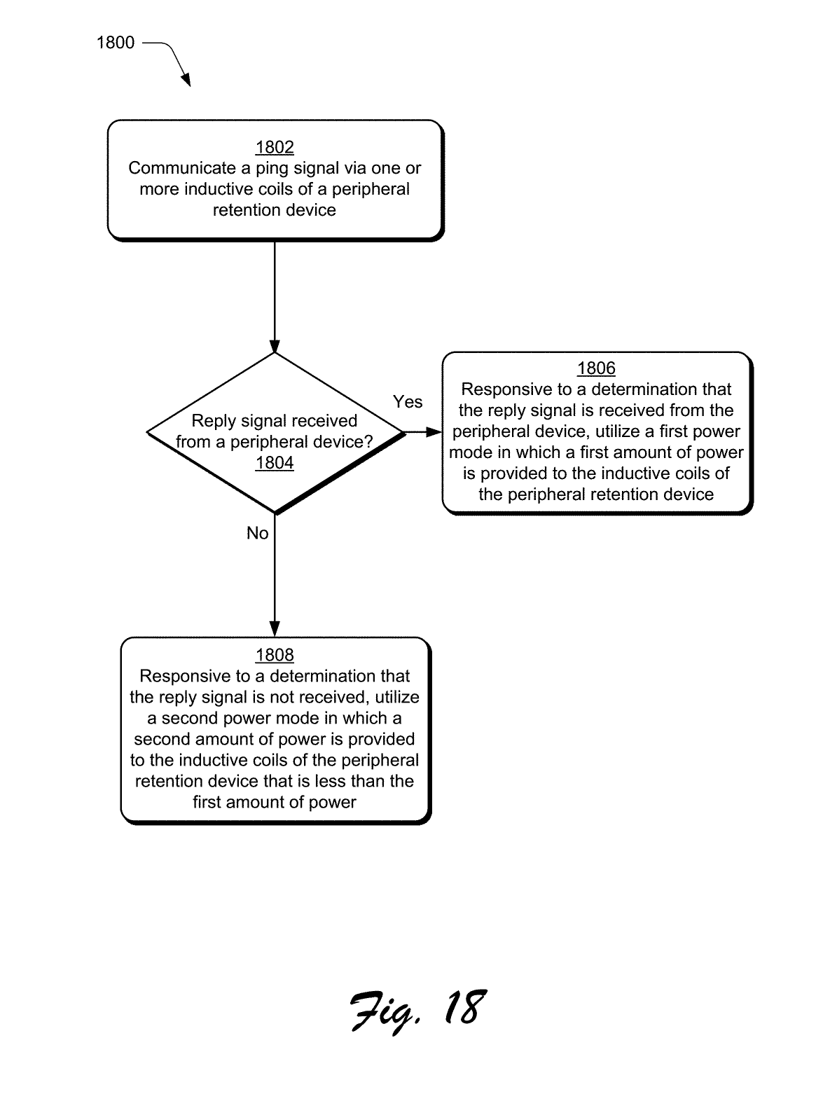

Accordingly, the charging module 1506 may detect that the flexible loop 214 and corresponding collapsed or shorted state and enter a reduced power mode 1510 that supplies less power to the inductive element 502 than when in the charging power mode 1508, e.g., may cease providing power all together, periodically provide power to determine inductance of the inductive element and thus whether to enter the charging power mode 1508, and so forth. In this way, the charging module 1506 may determine whether the peripheral retention device 110 is configured to perform inductance and react accordingly, such as to conserver power when not ready, transfer data, and so forth. Further discussion of this technique may be found in relation to FIG. 17.

Alternately, when the peripheral retention device 110 is implemented with inductive coils integrated into a flat surface of the peripheral retention device 110 (e.g., as illustrated in FIG. 10), the charging module 1506 may periodically communicate a ping signal via the inductive coils of the peripheral retention device. For example, the ping signal may be communicated every 5 seconds. In cases where the peripheral device is secured to the peripheral retention device (e.g., via one or more magnets), the peripheral device is configured to communicate a reply signal back to the peripheral retention device that is transmitted via inductive coils of the peripheral device and received via the inductive coils of the peripheral retention device. Notably, therefore, the ping and reply signals are transmitted and received using inductive coils, and thus a separate communication protocol (e.g., Bluetooth) is not needed.

If the charging module 1506 receives a reply signal back from the peripheral device, the charging module 1506 determines that the peripheral device is secured to the peripheral retention device, and in response provides a level of power sufficient to charge a peripheral device 122 (e.g., charging power mode 1508). In addition, the reply signal may indicate a level of battery charge on the peripheral device. The level of battery charge may be utilized by the charging module 1506 to determine when to shut off power to charge the battery of the peripheral device.

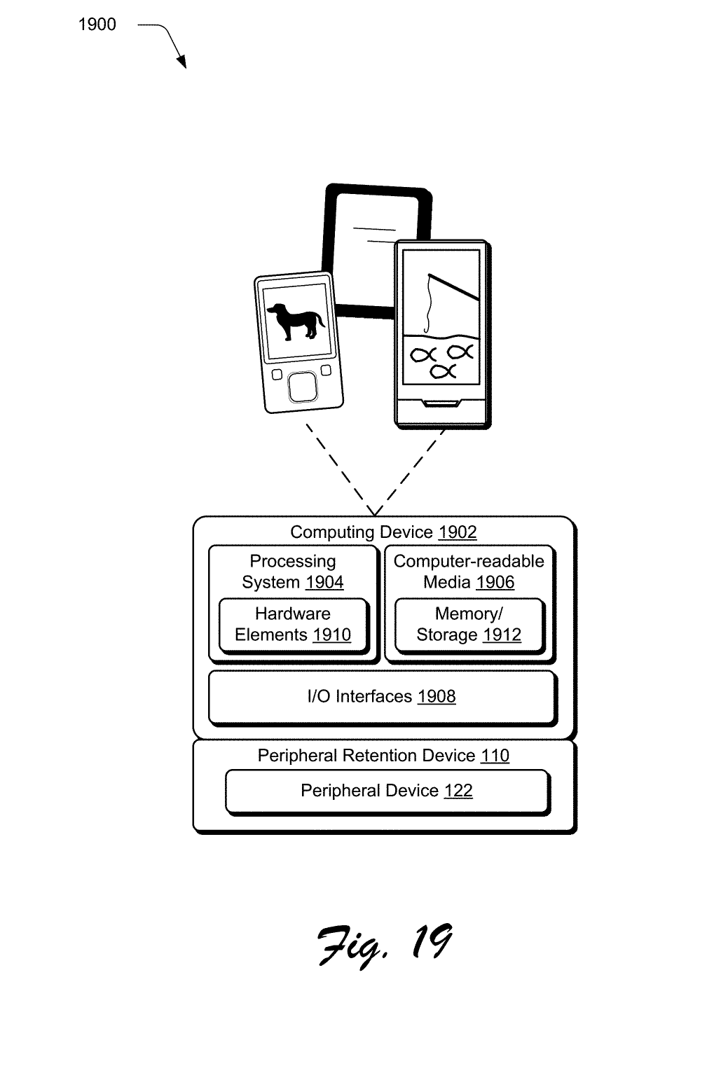

Alternately, if the charging module 1506 does not receive the reply signal, the charging module 1506 determines that the peripheral device is not secured to the peripheral retention device, and in response initiates the reduced power mode 1510 that supplies less power to the inductive coils than when in the charging power mode 1508. Further discussion of this technique may be found in relation to FIG. 18.

In one or more implementations, the peripheral device may be configured to initiate a low-power or standby mode in response to detection of the ping signal transmitted from the peripheral retention device.

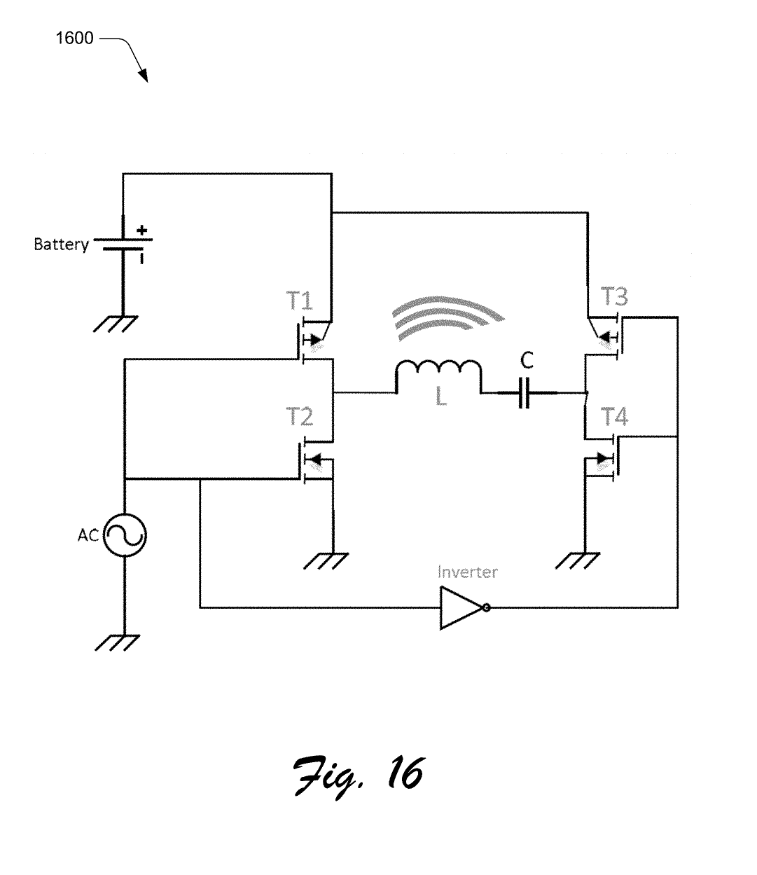

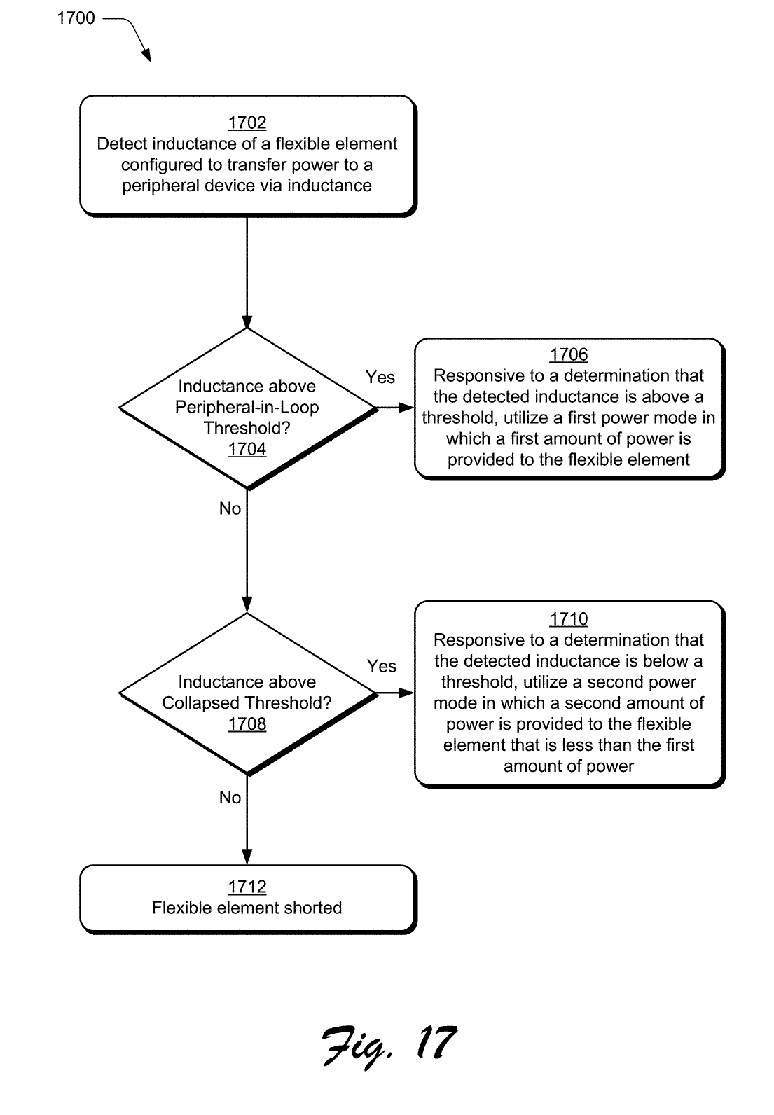

FIG. 16 depicts an example implementation of a circuit 1600 usable by the peripheral retention device 110 to act as a primary coil of an air gap transformer. As before, the primary coil may be utilized to transfer power to charge a peripheral device 122, transfer data, and so forth.

Example Procedures

The following discussion describes inductive peripheral retention device techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-16 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

FIG. 17 depicts a procedure 1700 in an example implementation in which power modes are utilized based on a determination of a detection of inductance of a flexible loop. There are three inductance scenarios, which may be detected and leveraged based on detection of inductance and/or current. These a scenario in which a peripheral device is not inserted (e.g., which has low inductance), a scenario in which a peripheral device is inserted (e.g., which has ten times the inductance of when a device is not inserted), and when an inductive element is not aligned with the flexible element but another metallic item is, which has the lowest inductance. Accordingly, thresholds may be utilized to differentiate between these scenarios, an example of which is described as follows.

Inductance is detected of a flexible element configured to transfer power to a peripheral device via inductance (block 1702). A charging module 1506, for instance, may measure inductance to determine whether the inductive element 502 is or is not experiencing a short.

At decision block 1704, a determination is made as to whether inductance is above a peripheral-in-loop threshold (decision block 1704). If so, (“yes” from decision bock 1704), responsive to a determination that the detected inductance is above a threshold, a first power mode is utilized in which a first amount of power is provided to the flexible element (block 1706). The threshold, for instance, may be set that is indicative of whether the inductive element is experiencing a short, set at an amount of inductance detected at a desired shape of the flexible element, e.g., the flexible loop 214 and corresponding inductive element 502) loop 214. If so, the charging module 1508 may provide an amount of power sufficient to transfer data, charge a peripheral device 122, and so forth.

In not (“no” from decision block 1704), a determination is made as to whether inductance is above a collapsed threshold (decision block 1708). If so (“yes” from decision block 1708), responsive to a determination that the detected inductance is below a threshold, a second power mode is utilized in which a second amount of power is provided to the flexible element that is less than the first amount of power (block 1710). This threshold may be the same or different than the previous threshold, e.g., may be set such that inductance levels below the threshold are indicative of a short, set for inductance levels detected at a flattened/collapsed shape of the flexible element (e.g., the flexible loop 214 and corresponding inductive element 502), and so forth.

If inductance is not above a collapsed threshold (“no” from decision block 1708), a determination is made that the flexible element is shorted (block 1712). A short circuit may be detected by inductance and also by detection of an excessive current draw above a threshold. Thus, a second power level may be employed, e.g., to “turn off” power to the inductive element 502, periodically check inductance at predetermined intervals of time, provide a minimal level of current usable to make the detection, and so forth. A timing profile may also be incorporated (e.g., 10 milliseconds on, two seconds off) to improve power savings. A variety of other examples are also contemplated without departing from the spirit and scope thereof.

FIG. 18 depicts a procedure 1800 in an example implementation in which different power modes are utilized in accordance with one or more implementations.

A ping signal is communicated via one or more inductive coils of a peripheral retention device integrated within a device (block 1802). A charging module 1506, for instance, may periodically communicate a ping signal via one or more inductive coils 1014 of a peripheral retention device 1002.

At decision block 1804, a determination is made as to whether a reply signal is received from a peripheral device secured to the peripheral retention device. For example, the charging module 1506 may monitor for a reply signal transmitted back to the peripheral retention device 1002 from a peripheral device 1010 secured to the peripheral retention device 1002 via one or more magnets 1006.

If so, (“yes” from decision bock 1804), responsive to a determination that a reply signal is received from the peripheral device, a first power mode is utilized in which a first amount of power is provided to the inductive coils of the peripheral retention device (block 1806). In the first power mode, the charging module 1508 may provide an amount of power sufficient to transfer data, charge a peripheral device 122, and so forth.

In not (“no” from decision block 1804), responsive to a determination that a reply signal is not received from the peripheral device, a second power mode is utilized in which a second amount of power is provided to the inductive coils of the peripheral retention device that is less than the first amount of power (block 1808). In the second power mode, the charging module 1508 determines that the peripheral device is not secured to the peripheral retention device, and thus may provide a lower amount of power to the inductive coils or “turn off” power to the inductive coils. A variety of other examples are also contemplated without departing from the spirit and scope thereof.

Example System and Device

FIG. 19 illustrates an example system generally at 1900 that includes an example computing device 1902 that is representative of one or more computing systems and/or devices that may implement the various techniques described herein. The computing device 1902 may be, for example, be configured to assume a mobile configuration through use of a housing formed and size to be grasped and carried by one or more hands of a user, illustrated examples of which include a mobile phone, mobile game and music device, and tablet computer although other examples are also contemplated. A peripheral retention device 110 is also included, which may be used to retain a peripheral device 122 as described above.

The example computing device 1902 as illustrated includes a processing system 1904, one or more computer-readable media 1906, and one or more I/O interface 1908 that are communicatively coupled, one to another. Although not shown, the computing device 1902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1904 is representative of functionality to perform one or more operations using hardware. Accordingly, the processing system 1904 is illustrated as including hardware element 1910 that may be configured as processors, functional blocks, and so forth. This may include implementation in hardware as an application specific integrated circuit or other logic device formed using one or more semiconductors. The hardware elements 1910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1906 is illustrated as including memory/storage 1912. The memory/storage 1912 represents memory/storage capacity associated with one or more computer-readable media. The memory/storage component 1912 may include volatile media (such as random access memory (RAM)) and/or nonvolatile media (such as read only memory (ROM), Flash memory, optical disks, magnetic disks, and so forth). The memory/storage component 1912 may include fixed media (e.g., RAM, ROM, a fixed hard drive, and so on) as well as removable media (e.g., Flash memory, a removable hard drive, an optical disc, and so forth). The computer-readable media 1906 may be configured in a variety of other ways as further described below.

Input/output interface(s) 1908 are representative of functionality to allow a user to enter commands and information to computing device 1902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1902 may be configured in a variety of ways to support user interaction.

The computing device 1902 is further illustrated as being physically coupled to a peripheral device 1914 that is physically removable from the computing device 1902, e.g., using magnetism. In this way, a variety of different input devices may be coupled to the computing device 1902 having a wide variety of configurations to support a wide variety of functionality.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1910 and computer-readable media 1906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1910. The computing device 1902 may be configured to implement particular instructions and/or functions corresponding to the software and/or hardware modules. Accordingly, implementation of a module that is executable by the computing device 1902 as software may be achieved at least partially in hardware, e.g., through use of computer-readable storage media and/or hardware elements 1910 of the processing system 1904. The instructions and/or functions may be executable/operable by one or more articles of manufacture (for example, one or more computing devices 1902 and/or processing systems 1904) to implement techniques, modules, and examples described herein.

Conclusion

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A device comprising:
a peripheral retention device comprising:
an inductive element comprising one or more inductive coils integrated into a surface of the peripheral retention device; and
a peripheral securing element configured to secure a peripheral device to the surface of the peripheral retention device to form a communicative coupling with the peripheral device via the one or more inductive coils.

2. The device of claim 1, wherein the peripheral securing element comprises one or more magnets configured to secure the peripheral device to the peripheral retention device such that the one or more inductive coils of the peripheral retention device are aligned with one or more corresponding inductive coils of the peripheral device.

3. The device of claim 1, wherein the one or more inductive coils comprise one or more flat traces configured to carry an electrical current to form the communicative coupling with the peripheral device via induction.

4. The device of claim 3, wherein the one or more flat traces are printed on a flexible printed circuit (FPC) of the peripheral retention device.

5. The device of claim 1, wherein the communicative coupling enabled by the one or more inductive coils is configured to charge the peripheral device using power received from the device.

6. The device of claim 1, wherein the communicative coupling enabled by the one or more inductive coils is configured to support two-way communication of data using induction between the device and the peripheral device.

7. The device of claim 1, wherein the device further comprises a memory and a processor to implement a charging module, the charging module configured to:
periodically communicate a ping signal via the one or more inductive coils;
initiate a charging power mode in response to receiving a reply signal from the peripheral device via the inductive coils; and
initiate a reduced power mode if the reply signal is not received.

8. The device of claim 7, wherein a first amount of power is provided to the inductive coils in the charging mode, and wherein a second amount of power that is less than the first amount of power is provided to the inductive coils in the reduced power mode.

9. The device of claim 1, wherein the peripheral retention device is removable from the device.

10. The device of claim 1, wherein the peripheral retention device is permanently integrated into the device.

11. The device of claim 1, wherein the peripheral device comprises a stylus, a mouse, a dial, a head-mounted display, headphones, ear buds, a smartwatch, or a smart band.

12. The device of claim 1, wherein a z-thickness of the peripheral retention device is less than 0.8 millimeters.

13. A method comprising:
communicating a ping signal via one or more inductive coils of a peripheral retention device integrated within a device;
determining whether a reply signal is received from a peripheral device secured to the peripheral retention device;
responsive to a determination that the reply signal is received, utilizing a first power mode in which a first amount of power is provided to the inductive coils of the peripheral retention device; and
responsive to a determination that the reply signal is not received, utilizing a second power mode in which a second amount of power is provided to the inductive coils of the peripheral retention device that is less than the first amount of power.

14. The method of claim 13, further comprising determining that the peripheral device is secured to the peripheral retention device if the reply signal is received, and determining that the peripheral device is not secured to the peripheral retention device if the reply signal is not received.

15. The method of claim 13, wherein, in the first power mode, the first amount of power provided to the inductive coils is sufficient to charge the peripheral device.

16. The method of claim 13, wherein, in the first power mode, the first amount of power provided to the inductive coils is sufficient to enable two-way communication with the peripheral device.

17. The method of claim 13, wherein the second amount of power does not provide power to the inductive coils of the peripheral retention device.

18. The method of claim 13, wherein the peripheral device is secured to the peripheral retention device via a magnetic coupling caused by one or more magnets of the peripheral retention device.

19. A device comprising:
a plurality of inductive coils integrated into a housing of the device that form a communicative coupling with a peripheral device via induction when the peripheral device is rested on the housing of the device, the communicative coupling enabling the transfer of power and data to the peripheral device.

20. The device of claim 19, wherein the device comprises an input device, and wherein the plurality of inductive coils are positioned on a flexible hinge of the input device.
